(19) United States
(12) Patent Application Publication
(10) Pub. No.: US 2015/0323379 A1
(43) Pub. Date: Nov. 12, 2015

(54) Optical Inertial Sensing Module

(71) Applicant: Mao-Jen Wu, Kaohsiung City (TW)

(72) Inventors: Mao-Jen Wu, Kaohsiung City (TW); Chia-Chi Chang, Taipei City (TW); Po-Kuan Shen, Emei Township (TW); Chin-Ta Chen, Fangyuan Township (TW); Mao-Yuan Zeng, Taoyuan City (TW); Lin-Yu Zhao, Taoyuan City (TW); Chi-Hsiang Lin, Longtan Township (TW); Shu-Hsuan Lin, New Taipei City (TW); Chien-Pang Lee, Daxi Township (TW); Teng-Hsiang Chang, Taoyuan City (TW)

(73) Assignee: Mao-Jen Wu, Kaohsiung City (TW)

(21) Appl. No.: 14/272,385

(22) Filed: May 7, 2014

(51) Int. Cl. G01H 9/00

(52) U.S. Cl. CPC G01H 9/004

(57) ABSTRACT

An optical inertial sensing module is proposed. The optical inertial sensing module includes a substrate, having a concave structure, and a through hole structure. The concave structure is formed on the top surface and has a first reflection surface and a second reflection surface, and the through hole structure passes through from the top surface to the bottom surface of the substrate. A light emitting device is disposed within the through hole structure of the substrate. A light-guiding structure is configured in the concave structure and located between the first reflection surface and the second reflection surface. At least one photo detector is disposed on the top surface of the substrate, and a mother board is used for the substrate configured thereon.

### TECHNICAL FIELD

The present invention relates to an optical sensor, and more particularly, to an optical inertial sensing module to measure vibration of an acoustic wave.

### BACKGROUND

Recently, the use of optical sensors has become more prevalent for sensing applications, particularly in those applications where the sensors must be placed in harsh environments, which seriously affects the performance/reliability of the associated electronics. Fiber optic sensors have an advantage in that they require no electronics at or near the sensor. In fiber optic sensors, light is sent through the optical fiber from a remote location.

Fiber optic sensors generally fall into two categories, those designed for making high speed dynamic measurements, and those designed for low speed, relatively static measurements. Examples of dynamic sensors include hydrophones, geophones, and acoustic velocity sensors, where the signal varies at a rate of 1 Hz and above. Examples of low speed (static) sensors include temperature, hydrostatic pressure, and structural strain, where the rate of signal change may be on the order of seconds, minutes or hours.

Many applications relate primarily to dynamic measurements of acceleration, acoustic velocity, and vibration using fiber optic sensors. The invention proposes a new optical sensing module for acoustic wave applications.

### SUMMARY OF THE INVENTION

In this invention, an optical inertial sensing module is proposed. The optical inertial sensing module comprises a substrate, having a top surface, a bottom surface, a concave structure, and a through hole structure, wherein the top surface is opposite to the bottom surface, the concave structure is formed on the top surface and has a first reflection surface and a second reflection surface opposite to the first reflection surface, and the through hole structure passes through from the top surface to the bottom surface of the substrate. A light emitting device is disposed within the through hole structure of the substrate, wherein the light emitting device is capable of emitting an optical signal. The module further comprises a light-guiding structure configured in the concave structure and located between the first reflection surface and the second reflection surface, at least one photo detector disposed on the top surface of the substrate, and a mother board for the substrate configured thereon.

According to one aspect, the module further comprises at least one control unit configured on the mother board and coupled to the mother board. The at least one control unit comprises a driver integrated circuit coupled to the light emitting device or a trans-impedance amplifier chip coupled to the photo detector.

According to another aspect, the module further comprises a fan-out transmission line formed on the top surface of the substrate, wherein the at least one control unit is coupled to the photo detector via the fan-out transmission line and a wire.

According to yet another aspect, the module further comprises a fan-out transmission line formed on a top surface of the mother board, wherein the at least one control unit is coupled to the light emitting device via the fan-out transmission line and a wire.

The light emitting device is capable of emitting visible and invisible light. In one embodiment, the concave structure has a third reflection surface and a fourth reflection surface opposite to the third reflection surface. Based-on the at least one groove of the concave structure, optical component (cable) may be passively aligned to the at least one groove.

In another example, the optical inertial sensing module comprises a film layer combined with a substrate, having a concave structure and a through hole structure, wherein the concave structure is formed on a sidewall surface of the film layer and a top surface of the substrate and has a first reflection surface and a second reflection surface opposite to the first reflection surface, and the through hole structure passes through from the top surface to a bottom surface of the substrate; wherein the film layer is formed on the top surface of the substrate. The at least one photo detector is disposed on the top surface of the film layer. A (fan-out) transmission line is formed on the top surface of the film layer, wherein the at least one control unit is coupled to the photo detector via the fan-out transmission line and a wire.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a block diagram of an optical inertial sensing system according to one embodiment of the invention;

FIG. 2 illustrates an optical inertial sensing module according to one embodiment of the invention;

FIG. 3 illustrates an optical inertial sensing module according to one embodiment of the invention;

FIG. 4 illustrates a substrate structure embedded with optical waveguide according to one embodiment of the invention;

FIG. 5 illustrates a driver integrated circuit (IC) coupled to the light source according to one embodiment of the invention;

FIG. 6 illustrates a trans-impedance amplifier coupled to the photo detector according to one embodiment of the invention;

FIGS. 7A˜7C illustrate an inertial sensor according to some embodiments of the invention;

FIG. 8 illustrates an optical inertial sensing module with single-axis inertial sensor according to one embodiment of the invention;

FIG. 9 illustrates an optical inertial sensing module with multi-axis inertial sensor according to one embodiment of the invention;

FIG. 10 illustrates a top view of a multi-axis inertial sensor integrated onto the substrate of the optical inertial sensing module according to one embodiment of the invention;

FIG. 11 illustrates a waveguide matrix array according to one embodiment of the invention;

FIG. 12 illustrates a sensing matrix array according to one embodiment of the invention.

FIG. 13 illustrates a quadrant polymer waveguide according to one embodiment of the invention;

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

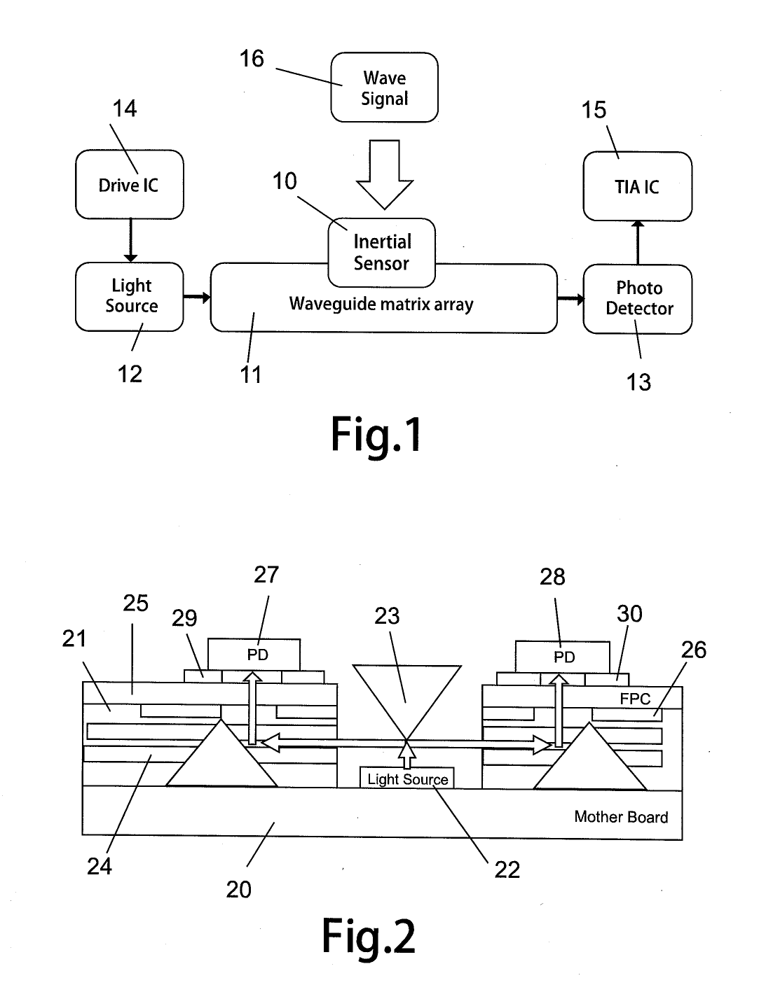

FIG. 1 illustrates a block diagram of an optical inertial sensing system according to one embodiment of the invention. The optical inertial sensing system can be used to detect sound waves, mechanical waves, seismic waves, sphygmus and any vibrating wave energy via other mediums. In this embodiment, the optical inertial sensing system comprises an inertial sensor 10, a light-guiding structure (waveguide matrix array) 11, a light emitting device (light source) 12, photo detectors 13, driver IC 14 and IC chip 15. The driver integrated circuit (IC) 14 is coupled to drive the light source 12. The IC chips or circuits 15 can let signal amplifier or analyze the detecting optical signal. For example, IC chips 15 are trans-impedance amplifier (TIA). The trans-impedance amplifier (TIA) chip 15 is electrically connected (coupled) to the photo detector 13. In one embodiment, the light source 12 is capable of emitting visible or invisible light. The inertial sensor 10 may be detected for wave signal 16. Optical paths created by the light source 12 are changed in the waveguide matrix array 11 as signal wave 16 attacks to the inertial sensor 10. Then, intensity detected by the photo detectors 13 is changed with the vibration of the inertial sensor 10. Therefore, wave signal 16 may be detected via vibration of the inertial sensor 10.

FIG. 2 shows an optical inertial sensing module according to one embodiment of the invention. In this embodiment, the optical inertial sensing module comprises a mother board 20, a substrate 21, a light emitting device (light source) 22, an inertial sensor 23, a light-guiding structure (optical waveguide) 24, a flexible printed board 25, a rigid member (stainless layer) 26, photo detectors 27 and 28, and contact pads 29 and 30. A driver integrated circuit (IC) may be coupled to drive the light source 22. The IC chips or circuits may be electrically connected (coupled) to the photo detectors 27 and 28. The photo detectors 27 and 28 have pad 29 and 30, respectively, electrically connected (coupled) to the flexible printed board 25. The photo detectors 27 and 28 are disposed on the flexible printed board 25. The light source 22 and the substrate 21 are disposed on (above) the upper surface of the mother board 20, for example adhered on the upper surface of the mother board 20 via adhesive layer. In one embodiment, the mother board 20 is a printed circuit board (PCB) or a flexible PCB. In one embodiment, the light source 22 is capable of emitting visible or invisible light. The light-guiding structure 24 may be embedded into the substrate 21. The substrate 21 has a concave structure for the light-guiding structure 24 disposed therein, and a through hole structure passing through top surface to bottom surface of the substrate 21 for the light source 22 and the inertial sensor 23 disposed therein. Also, the flexible printed board 25 and the rigid member (stainless layer) 26 have a through hole structure passing through top surface to bottom surface of the flexible printed board 25 and the rigid member 26 for the inertial sensor 23 disposed therein. The rigid member 26 is disposed (formed) between the flexible printed board 25 and the substrate 21 to reinforce strength of the flexible printed board 25. The inertial sensor 23 may be detected for wave signal. The light source 22 is disposed under the inertial sensor 23. Optical paths created by the light source 22 are changed in the light-guiding structure 24 due to the inertial sensor 23 vibrating, as signal wave attacks to the inertial sensor 23. Then, intensity detected by the photo detectors 27 or 28 may be detected with the vibration of the inertial sensor 23. Therefore, wave signal may be detected via vibration of the inertial sensor 23.

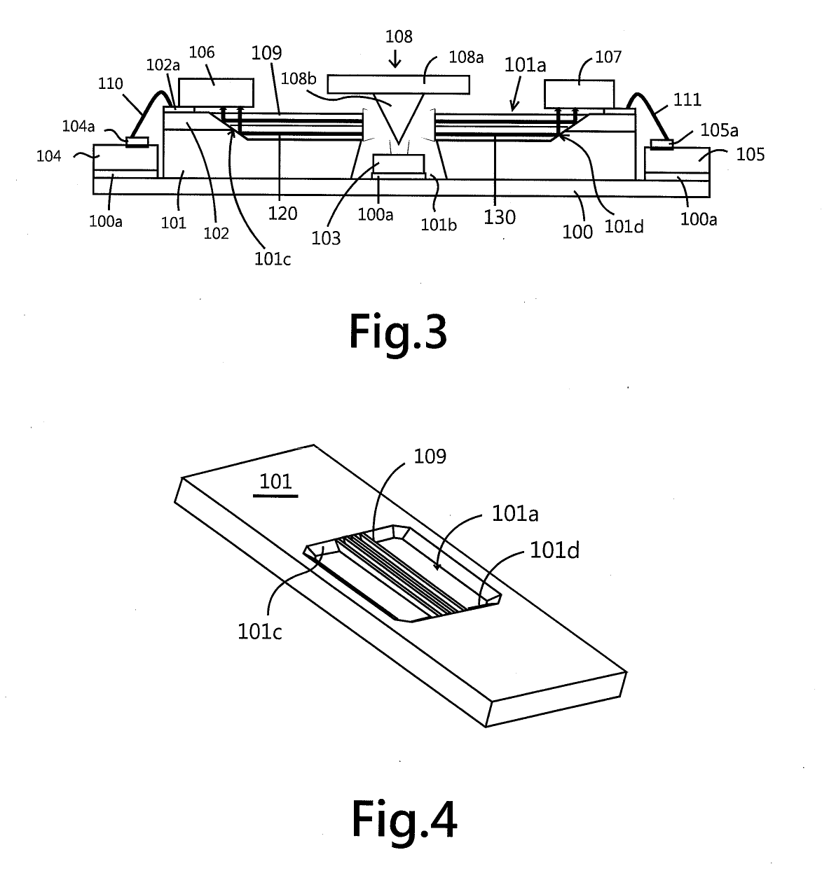

FIG. 3 shows an optical inertial sensing module according to one embodiment of the invention. The optical inertial sensing module can be used as a vibration sensing element (device), which may be made by employing a standard semiconductor manufacturing process. Optical elements are applied to the vibration sensing element as sensing system. The sensing system or sensing device (optical inertial sensing module) can detect sound waves, mechanical waves, seismic waves, sphygmus and any vibrating wave energy via other mediums. Especially, the proposed optical inertial sensing module can be applied for 3D (three dimensional) sound localization microphone, ultrasound gesture recognition for touch-less interactive display, or ambience monitoring, monitoring plus acoustic guidance, phone call (comfort whilst talking) or full isolation (noise suppression). For example, microphone for wearable mobile device is able to identify the location or origin of voice command within a 3D space. The optical inertial sensing module applied for 3D sound localization may be integrated with MEMS inertial sensor (accelerometer, gyroscope) and MEMS microphone (for example, Google glass). In one embodiment, audio source localization system may be used to support applications that generate an output audio signal for acoustic transmission such as video gaming applications that take into account the position of a player in a room or other area or surround sound applications that perform proper sound localization based on the position of a listener. In another embodiment, sensor-less input object need not be specially designed or suited for use in the gesture recognition system. For example, a user's naked hand could be used as the sensor-less input object, and thus a user need not wear a glove that includes retro-reflective material or one or more position sensors to provide gesture inputs to the gesture recognition system. For sound localization and gesture recognition, they are considering amplitude, frequency and spatial phase of acoustic wave. In this embodiment, the optical inertial sensing module comprises a mother board 100, a substrate 101, a film layer 102, a light emitting device (light source) 103, IC chips or circuits 104 and 105, photo detectors 106 and 107, an inertial sensor 108, and a light-guiding structure (optical waveguide) 109. A driver integrated circuit (IC) is coupled to drive the light source 103. The IC chips or circuits 104 and 105 can let signal amplifier or analyze the detecting optical signal. For example, IC chips 104 and 105 are trans-impedance amplifier (TIA). The trans-impedance amplifier (TIA) is a current to voltage converter. The TIA can be used to amplify the current output of the photo detectors and other types of sensors. The trans-impedance amplifier (TIA) chip 104 is electrically connected (coupled) to the photo detector 106 via wire 110. The trans-impedance amplifier (TIA) chip 105 is electrically connected (coupled) to the photo detector 107 via wire 111. The photo detectors 106 and 107 are disposed on the film layer 102. The light source 103 and the trans-impedance amplifier (TIA) chips 104 and 105 are disposed on (above) the upper surface of the mother board 100, for example adhered on the upper surface of the mother board 100 via adhesive layer 100a. In one embodiment, the mother board 100 is a printed circuit board (PCB) or a flexible PCB. In one embodiment, the light source 103 is capable of emitting visible or invisible light. The light source 103 is for example a laser, an infrared light source, a light emitting diode (LED), or OLED (organic light emitting diode). Infrared light is in infrared band, which can be emitted by laser or LED. The light-guiding structure 109 comprises a fiber, a waveguide or a jumper.

FIG. 4 shows a substrate structure embedded with optical waveguide according to one embodiment of the invention. The substrate 101 has a concave structure (trench) 101a and a through hole structure (opening) 101b (not shown in FIG. 4). The depth of the trench 101a may be 2˜350 microns, or even the trench 101a passing through the substrate 101 to form a via hole. The trench 101a may be formed by an etching process. For example, the opening 101b may locate on center area of the substrate 101. In one embodiment, the light source 103 is located on the mother board 100 within the opening 101b of the substrate 101, shown in FIG. 3. In another embodiment, the light source 103 may be located (attached) on the substrate 101, for example the substrate 100 having a bench retained on the area of the opening 101b for the light source 103 attached thereon. The substrate 101 has at least one optical micro-reflection surface 101c and optical micro-reflection surface 101d at two sides of (within) the trench 101a of the substrate 101. The optical waveguide 109 is formed (attached/mounted) on bottom surface (except the area of the opening 101b) of the trench 101a of the substrate 101 for guiding light, while exposing upper surface of the optical waveguide 109. The light-guiding structure 109 is configured in the concave structure 101a and located between the first reflection surface 101c and the second reflection surface 101d. In one embodiment, the optical waveguide 109 is made of a flexible material, for example multiple polymer waveguides. The height of the optical waveguide 109 may be 10˜200 microns. The width of the optical waveguide 109 may be 10˜200 microns. The optical waveguide 109 may be a membrane. In one embodiment, two sides of the optical waveguide 109 with inclined plane full connected to (formed on) the optical micro-reflection surface 101c and the optical micro-reflection surface 101d of the substrate 101, respectively. The optical waveguide 109 is allowable for optical paths 120 and 130 therein, for facilitating light irradiated from the light source 103 passing through therein. For example, the light source 103 is located (attached) on top surface of the mother board 100, within the opening 101b of the substrate 101, and the light source 103 is located under the inertial sensor 108 (near bottom of the inertial sensor 108). Therefore, optical signal of the light source 103 is emitted in bottom-up direction to reach the inertial sensor 108. As the inertial sensor 108 vibrates, the optical signal emitted by the light source 103 enters into the optical waveguide 109 via the pyramid-shape structure 108b, followed by reflected by the reflection surface 101c or 101d of the substrate 101, and received by the photo detectors 106 or 107.

The substrate 101 is used to be as an optical bench, and has a concave bench on bottom surface of the trench 101a of the substrate 101 for facilitating the optical waveguide 109 to be disposed therein, and the optical micro-reflection surface 101c, 101d having a specified angle (such as 45 degree angle or other degree angle). In one embodiment, the trench (concave structure) 101a of the substrate 101 is in a specified depth beneath the top surface of the substrate 101. The film layer 102 is formed on the substrate 101. Material of the film layer 102 is a dielectric material, such as silicon dioxide. The film layer 102 has micro reflector having a specified angle (such as 45 degree angle or other degree angle) which is the same as the optical micro-reflection surface 101c, 101d. In one embodiment, the film layer 102 is omitted, shown in FIG. 4. In this example, the photo detectors 106 and 107 are disposed on the substrate 101. A first micro reflector is defined at a first end (left side) of the bench 101a of the substrate 101, and a second micro reflector is defined at a second end (right side) of the bench 101a of the substrate 101. The first end of the bench 101a of the substrate 101 forms a first reflection surface for the photo detector 106, and the second end of the bench 101a of the substrate 101 forms a second reflection surface for the photo detector 107. The bench 101a of the substrate 101 has a first slant plane 101c and a second slant plane 101d. In one embodiment, the first slant plane 101c is opposite to the second slant plane 101d.

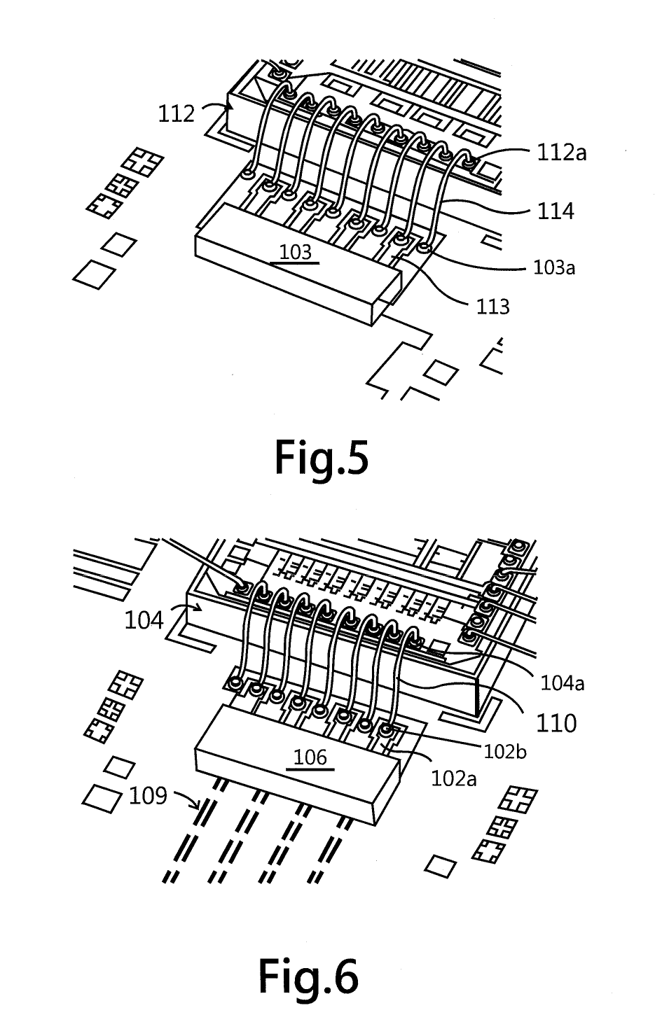

FIG. 5 shows a driver integrated circuit (IC) coupled to the light source according to one embodiment of the invention. A driver integrated circuit (IC) 112 is electrically connected (coupled) to the light source 103 via wire 114. In one embodiment, the light source 103 and the driver integrated circuit (IC) 112 are disposed on the substrate 101 electrically connected (coupled) to each other in IC flip-chip type. The wire 114 is electrically connected (coupled) to solder ball 103a and solder ball 112a (or pad). The solder ball 112a is formed on the driver integrated circuit (IC) 112 for coupling thereto. The solder ball 103a is formed on transmission line 113 for coupling the light source 103. The transmission line 113 may be a fan-out transmission line.

FIG. 6 shows a trans-impedance amplifier coupled to the photo detector according to one embodiment of the invention. In this embodiment, the photo detector 106 is for example. Other photo detectors may be referred to the FIG. 6. A trans-impedance amplifier 104 is electrically connected (coupled) to the photo detector 106 via wire 110. In one embodiment, the trans-impedance amplifier 104 and the photo detector 106 are disposed on the substrate 101 electrically connected (coupled) to each other in IC flip-chip type. The wire 110 is electrically connected (coupled) to solder ball 104a and solder ball 102b (or pad). The solder ball 104a is formed on the trans-impedance amplifier 104 for coupling thereto. The solder ball 102b is formed on transmission line 102a for coupling the photo detector 106. The transmission line 102a may be a fan-out transmission line. In one embodiment, the photo detector 106 is located (attached) on top surface of the substrate 101 (or film layer 102) at left side of the substrate 101. The optical signal emitted by the light source 103 from the optical waveguide 109 is received by the photo detector 106. Then, the optical signal may be amplified by the trans-impedance amplifier (TIA) chip 104.

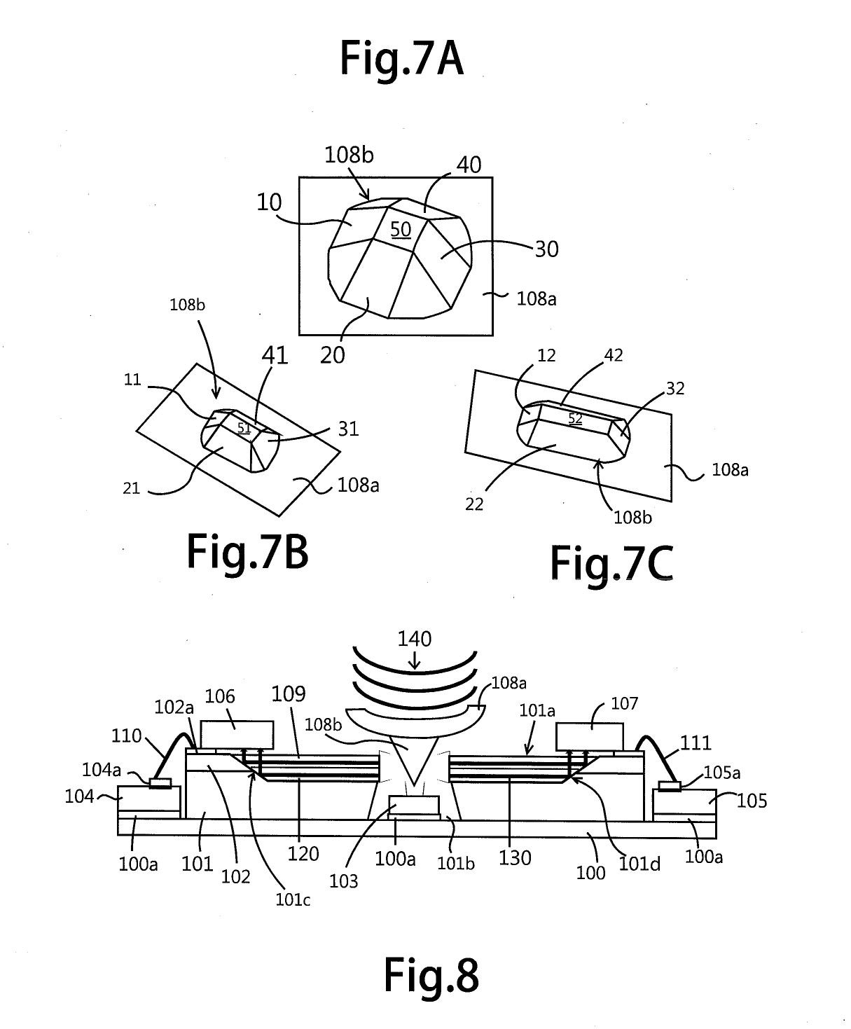

FIGS. 7A-7C show an inertial sensor according to some embodiments of the invention. The inertial sensing element (sensor) may be a multi-axis inertial sensor or a single-axis inertial sensor. The inertial sensor may detect amplitude, frequency and spatial phase of acoustic signal (wave) based-on stress thereon. One of many examples of a conventional inertial sensor that can be easily adapted for use with the interactive virtual display for implementing wearable sensors is the well-known Shimmer™ device by “Shimmer Research”. In this embodiment, the inertial sensor 108 is a pyramid-shaped inertial sensor which has a pyramid-shape structure 108b with regular polygon faces for light reflection. The inertial sensor 108 is composed of a base 108a and a pyramid-shape (or others shape) structure 108b formed thereon used for vibration detection. The base 108b is for example a silicon base, silicon dioxide film or silicon nitride film. In one embodiment, the pyramid-shape structure 108b has a top surface 50, 51 or 52 and four inclined planes (10, 20, 30, 40), (11, 21, 31, 41) or (12, 22, 32, 42), shown in FIGS. 7A, 7B and 7C, respectively. The top surface 50, 51 or 52 has a quadrangle with different size, for example square shape (shown in FIG. 7A) or rectangle shape with different length (shown in FIG. 7B, FIG. 7C). Each of the four inclined planes of the pyramid-shape structure 108b with a specified angle (such as 45 degree angle or other degree angle) may be used for reflecting light from the light source 103.

As signal wave 140 with zero degree incident angle reaches to the base 108a of the single-axis inertial sensor 108 of the optical inertial sensing module (vibration sensing device), the pyramid-shape structure 108b is then vibrated up or down, caused by stress of the base 108a stricken by the signal wave 140, shown in FIG. 8. The signal wave is for example an acoustic signal wave. Optical signals from the light source 103 are influenced by the vibration of the single-axis inertial sensor 108. Therefore, optical paths 120 and 130 created by the light source 103 are changed in the optical waveguide 109. Thus, detection position of the photo detectors 106 and 107 is changed with the vibration of the single-axis inertial sensor 108, in comparison with non-vibration of the single-axis inertial sensor 108. The intensity of reflecting light detected of the photo detectors 106 and 107 is converted into electrical signal output. Amplitude, frequency and spatial phase of the acoustic signal wave 140 may be analyzed. In an embodiment, distance and position of the acoustic signal wave 140 source can be further determined. Accordingly, function of vibration-detection can be achieved.

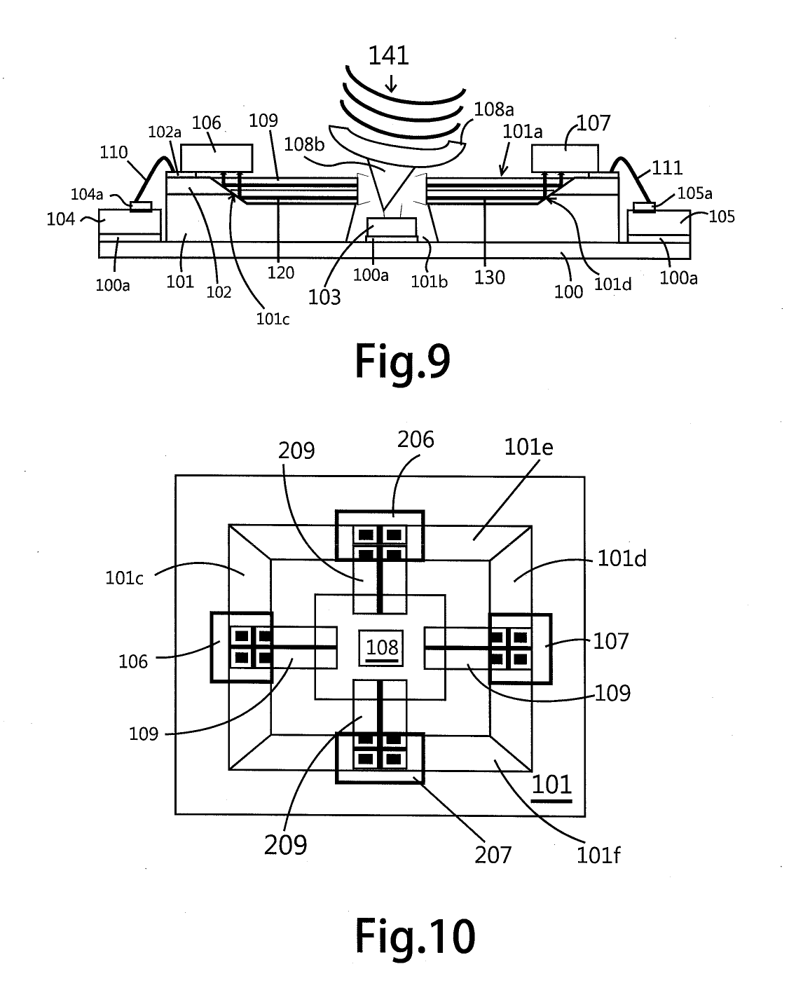

In another embodiment, as signal wave 141 with an inclined incident angle reaches to the base 108a of the multi-axis inertial sensor 108 of the optical inertial sensing module (vibration sensing device), the pyramid-shape structure 108b is then vibrated left or right, caused by stress of the base 108a stricken by the signal wave 141, shown in FIG. 9. In an embodiment, the pyramid-shape structure 108b is vibrated up or down as signal wave 141 has a zero degree incident angle. Optical signals from the light source 103 are influenced by the vibration of the multi-axis inertial sensor 108. Therefore, optical paths 120 or 130 created by the light source 103 are changed in the optical waveguide 109. In an embodiment, all light emitted by the light source 103 are propagating through the optical waveguide 109 at right side via the optical paths 130. Partial light passes through the optical waveguide 109 at left side. The detection position of the photo detector 107 is changed with the vibration of the multi-axis inertial sensor 108, in comparison with non-vibration of the multi-axis inertial sensor 108. The intensity of reflecting light detected of the photo detector 107 is converted into electrical signal output. The invention proposes an optical sensing system as vibration-detection system. Amplitude, frequency and spatial phase of the acoustic signal wave 141 may be analyzed. In an embodiment, distance and position of the acoustic signal wave 141 source and the inclined incident angle can be further determined. Accordingly, function of vibration-detection can be achieved. In an embodiment, spatial angular resolution of the optical inertial sensing module is smaller than 10 degree. Operation frequency of the optical inertial sensing module is from 1 Hz to 100000 Hz.

Based-on the sensing of the optical inertial sensing module (vibration sensing device), function of vibration-detection can be achieved. The inertial sensor is used to be as a vibration-detection component with vibration sensing function for detecting sound waves, mechanical waves, seismic waves, sphygmus . . . and shock wave energy arisen by any other medium shocking. The optical waveguide 109 integrates the light source 103 and the photo detectors 106, 107 to be as an optical sensing system. Thus, the invention proposes an optical sensing system as vibration-detection system.

Material and thickness of the substrate 101 and the optical waveguide 109 may be selected, based-on requirements for practical applications (various signal waves, detected sources). For example, material of the substrate 101 is silicon. Therefore, the trench 101a of the substrate 101 may be formed by a standard semiconductor process (photolithography process, etching process). In an embodiment, the optical waveguide 109 is a flexible thin film. Material of the optical waveguide 109 includes polymer material, dielectric material.

In an embodiment, the substrate 101 has an opening or a bench for the inertial sensor 504 disposed therein (thereon). The inertial sensor 108 is disposed (attached/mounted) above the light source 103. In one embodiment, the pyramid-shape structure 108b of the inertial sensor 108 extends into the opening 101b of the substrate 101, and thereby the inertial sensor 108 capable of reflecting light from the light source 103. The optical waveguide 109 is integrated onto the substrate 101 for light guiding. Light created by the light source 103 may be reflected via the first optical micro-reflection surface 101c and the second optical micro-reflection surface 101d at two sides of the substrate 101, respectively. The light source 103, the trans-impedance amplifier (TIA) chips 104, 105 are disposed on the center, two sides of upper surface of the mother board 100 and coupled to the mother board 100 via a wire, a electrical connection pad (solder ball) and a conductive pattern/transmission line (not shown).

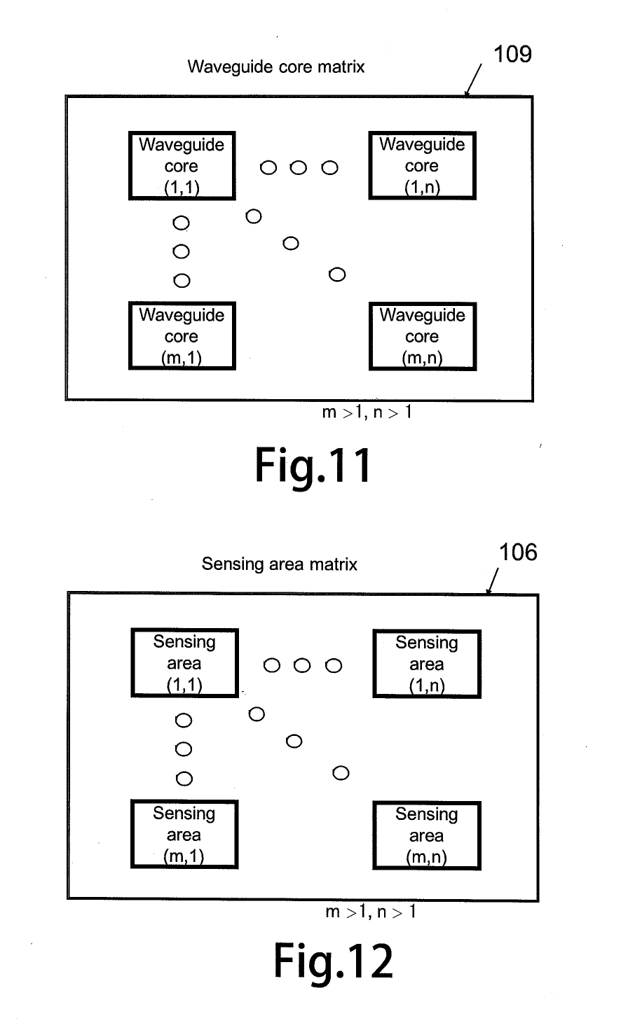

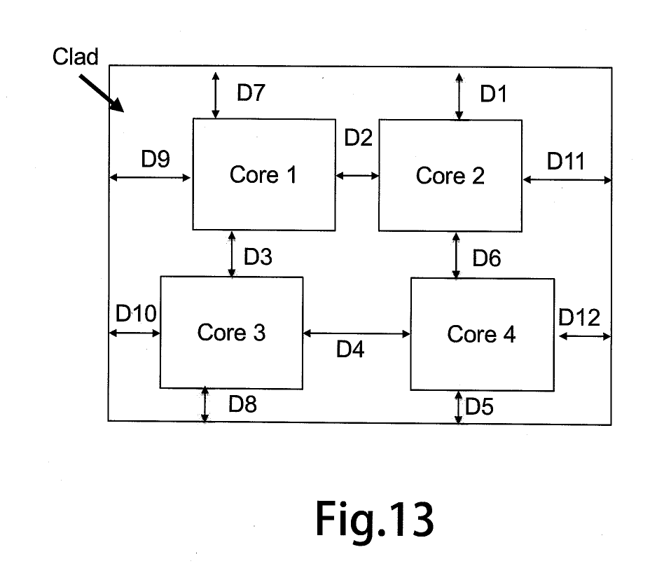

FIG. 10 shows a top view of a multi-axis inertial sensor integrated onto the substrate according to one embodiment of the invention. In this embodiment, the inertial sensor 108 is a multi-axis inertial sensor. As signal wave with an inclined incident angle reaches to the base 108a of the multi-axis inertial sensor 108 of the optical inertial sensing module, the pyramid-shape structure 108b is vibrated left or right, front and rear; as signal wave with zero degree incident angle reaches to the base 108a of the multi-axis inertial sensor 108 of the optical inertial sensing module, the pyramid-shape structure 108b is vibrated up or down. In other words, vibration of the multi-axis inertial sensor 108 includes six directions (up, down, left, right, front, rear). In one embodiment, when the multi-axis inertial sensor 108 vibrates up or down, the reflected light at optical micro-reflection surface 101c or 101d from the light source 103 is received by the photo detector 106 or 107 via the optical waveguide 109. In another embodiment, when the multi-axis inertial sensor 108 vibrates left or right, front or right, the reflected light at optical micro-reflection surface 101c or 101d, 101e or 101f from the light source 103 is received by the photo detector 106 or 107, photo detector 206 or 207 via the optical waveguide 109, or optical waveguide 209, respectively. In this embodiment, the optical waveguide 109 may be a quadrant optical waveguide with core 1, core 2, core 3, core 4, for example quadrant polymer waveguide, shown in FIG. 13, to meet the requirement for quadrant photo detectors 106, 107, 206, 207. Distances between core 1˜core 4 includes D2, D3, D4, and D6, shown in FIG. 13. Distances between (core 1˜core 4) and cladding includes D1, D5, D7, D8, D9, D10, D11 and D12, shown in FIG. 13. In one embodiment, distance of D1, D5, D7 and D8 is zero to 500 μm (microns). In one embodiment, distance of D2, D3, D4, D6, D9, D10, D11 and D12 is 1 to 500 μm (microns). The sensing matrix area 106 is shown in FIG. 12, which indicates that (m×n) sense amplifiers SA (1, 1) . . . SA (1, n) . . . SA (m, 1) . . . SA (m, n) are needed in the photo detector 106 for measuring laser pointing stability. In one embodiment, waveguide matrix area 109 is shown in FIG. 11, which indicates that (m×n) waveguide cores (1, 1) . . . (1, n) . . . (m, 1) . . . (m, n) are needed in the optical waveguide.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This structure of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. An optical inertial sensing module, comprising:
a substrate, having a concave structure and a through hole structure, wherein said through hole structure passes through from a top surface to a bottom surface of said substrate;
a light emitting device, disposed within said through hole structure of said substrate, wherein said light emitting device is capable of emitting an optical signal; and
an inertial sensor, disposed above said light emitting device, wherein said inertial sensor extends into said through hole structure of said substrate for reflecting light emitted from said light emitting device.

2. The module of claim 1, further comprising a light-guiding structure configured in said concave structure.

3. The module of claim 1, further comprising at least one photo detector disposed on said top surface of said substrate.

4. The module of claim 1, further comprising a mother board for said substrate configured thereon.

5. The module of claim 1, further comprising a flexible printed board configured on said substrate.

6. An optical inertial sensing module, comprising:
a substrate, having a concave structure and a through hole structure, wherein said concave structure is formed on a top surface of said substrate and has a first reflection surface and a second reflection surface opposite to said first reflection surface, and said through hole structure passes through from said top surface to a bottom surface of said substrate;
a light emitting device, disposed within said through hole structure of said substrate, wherein said light emitting device is capable of emitting an optical signal; and
an inertial sensor, disposed above said light emitting device, wherein said inertial sensor extends into said through hole structure of said substrate for reflecting light from said light emitting device.

7. The module of claim 6, further comprising a light-guiding structure configured in said concave structure and located between said first reflection surface and said second reflection surface.

8. The module of claim 6, further comprising at least one photo detector disposed on said top surface of said substrate.

9. The module of claim 6, further comprising a mother board for said substrate configured thereon.

10. The module of claim 9, further comprising at least one control unit configured on said mother board and coupled to said mother board.

11. The module of claim 10, wherein said at least one control unit comprises a driver integrated circuit, a trans-impedance amplifier chip, an IC or a circuit.

12. The module of claim 9, further comprising a fan-out transmission line formed on a top surface of said mother board, wherein said at least one control unit is coupled to said light emitting device via said fan-out transmission line and a wire.

13. The module of claim 6, further comprising a fan-out transmission line formed on said top surface of said substrate, wherein said at least one control unit is coupled to a photo detector via said fan-out transmission line and a wire.

14. An optical inertial sensing module, comprising:
a film layer combined with a substrate, having a concave structure and a through hole structure, wherein said concave structure is formed on a sidewall surface of said film layer and a top surface of said substrate and has a first reflection surface and a second reflection surface opposite to said first reflection surface, and said through hole structure passes through from said top surface to a bottom surface of said substrate;
wherein said film layer is formed on said top surface of said substrate;
a light emitting device, disposed within said through hole structure of said substrate, wherein said light emitting device is capable of emitting an optical signal; and
an inertial sensor, disposed above said light emitting device, wherein said inertial sensor extends into said through hole structure of said substrate for reflecting light from said light emitting device.

15. The module of claim 14, further comprising a light-guiding structure configured in said concave structure and located between said first reflection surface and said second reflection surface.

16. The module of claim 14, further comprising at least one photo detector disposed on said top surface of said film layer.

17. The module of claim 14, further comprising a mother board for said substrate configured thereon.

18. The module of claim 17, further comprising at least one control unit configured on said mother board and coupled to said mother board.

19. The module of claim 17, further comprising a fan-out transmission line formed on a top surface of said mother board, wherein said at least one control unit is coupled to said light emitting device via said fan-out transmission line.

20. The module of claim 14, further comprising a fan-out transmission line formed on said top surface of said film layer, wherein said at least one control unit is coupled to an photo detector via said fan-out transmission line and a wire.
